(19) United States
(12) Patent Application Publication
(10) Pub. No.: US 2025/0277461 A1
(43) Pub. Date: Sep. 4, 2025

(54) SYSTEMS AND METHODS FOR ENGINE VALVE COOLING

(71) Applicant: Eaton Intelligent Power Limited, Dublin 4 (IE)

(72) Inventors: Pierfrancesco De Giovanni, Corsano (IT); Marco Aimo Boot, Nole (IT); Luigi Lia, Torino (IT)

(21) Appl. No.: 19/179,875

(22) Filed: Apr. 15, 2025

Related U.S. Application Data
(63) Continuation of application No. PCT/EP2023/025446, filed on Oct. 25, 2023.
(60) Provisional application No. 63/380,820, filed on Oct. 25, 2022.

(51) Int. Cl. F01L 3/16

(52) U.S. Cl. CPC F01L 3/16; F01L 2301/00; F01L 2810/01

(57) ABSTRACT

A valve for a pressurizable enclosure includes a valve head provided at a first portion of the valve, a connecting portion extending between the first portion and a second portion of the valve, a chamber comprising a hollow portion, and a first body disposed within the chamber. The valve head is configured to selectively permit fluid flow into or out of the pressurizable enclosure. The hollow portion of the chamber is provided at least partially within the connecting portion and configured to contain a filler material. The first body is configured to be movable within the chamber during valve operation.

### PRIORITY

This application is a continuation under 35 U.S.C. § 365(c) of International Patent Application No. PCT/EP2023/025446, filed on 25 Oct. 2023, which claims the benefit under 35 U.S.C. § 119(e) of U.S. Provisional Patent Application No. 63/380,820, filed on 25 Oct. 2022, all of which are incorporated herein by reference in their entirety.

### TECHNICAL FIELD

The present disclosure relates generally to valves and, more particularly, to valves designed for improved cooling performance.

### BACKGROUND

Engine valves can experience large thermal loads due to the flow of hot gases from engine cylinders. The large thermal loads experienced by valves may cause them to fail. There is a need to improve cooling of valves during engine operation to facilitate reduced operating temperatures, improved performance, and extended operating life of the valves.

### SUMMARY

In particular embodiments, a valve for a pressurizable enclosure is disclosed, the valve including: a valve head provided at a first portion of the valve and configured to engage with the pressurizable enclosure to selectively permit fluid flow into or out of the pressurizable enclosure; a connecting portion extending between the first portion and a second portion of the valve provided opposite the first portion; a chamber including a hollow portion provided at least partially within the connecting portion and configured to contain a filler material; and a first body disposed within the chamber; wherein, during valve operation, the first body is configured to be movable within and relative to the chamber to facilitate reducing an operating temperature of the valve.

In particular embodiments, which may combine the features of some or all of the above embodiments, the filler material includes a fluid medium during valve operation, and wherein the first body is at least partially immersed in the fluid medium during valve operation. In particular embodiments, which may combine the features of some or all of the above embodiments, valve operation includes a periodic translation or a reciprocal motion of the valve relative to the pressurizable enclosure along a longitudinal axis.

In particular embodiments, which may combine the features of some or all of the above embodiments, the chamber includes an elongated portion oriented along a longitudinal axis of the valve, and wherein the first body is configured to reciprocate or translate within the elongated portion of the chamber during valve operation. In particular embodiments, which may combine the features of some or all of the above embodiments, the first body includes an elongated portion provided coaxially with the elongated portion of the chamber.

In particular embodiments, which may combine the features of some or all of the above embodiments, the valve further includes one or more second bodies disposed within the chamber, each second body configured to be movable within and relative to the chamber during valve operation.

In particular embodiments, which may combine the features of some or all of the above embodiments, the first body includes a first portion, a second portion provided opposite the first portion, and a third portion disposed between the first portion and the second portion. In particular embodiments, which may combine the features of some or all of the above embodiments, the third portion includes an elongated section oriented along a longitudinal axis of the valve. In particular embodiments, which may combine the features of some or all of the above embodiments, one or more of the first portion and the second portion are configured to taper along a direction away from the third portion. In particular embodiments, which may combine the features of some or all of the above embodiments, the first body includes a spherical portion or a hemispherical portion.

In particular embodiments, which may combine the features of some or all of the above embodiments, the valve is an intake valve or an exhaust valve of a combustion engine, and wherein a motion of the first body within and relative to the chamber during valve operation permits an increased rate of heat transfer through the connecting portion of the valve to facilitate reducing the operating temperature of the valve. In particular embodiments, which may combine the features of some or all of the above embodiments, the filler material includes sodium.

In particular embodiments, which may combine the features of some or all of the above embodiments, reducing an operating temperature of the valve includes reducing a mean temperature of the valve head during valve operation.

In particular embodiments, which may combine the features of some or all of the above embodiments, a method to facilitate reducing an operating temperature of a valve of a pressurizable enclosure is disclosed, the method including: providing a movable first body within a chamber of the valve, the chamber provided at least partially within a connecting portion extending between a valve head and a valve end of the valve, the chamber configured to contain a filler material, the filler material including a fluid medium during valve operation, the first body at least partially immersed in the fluid medium during valve operation; and operating the valve by periodically translating the valve relative to the pressurizable enclosure along a longitudinal axis such that the first body moves within and relative to the chamber to facilitate reducing an operating temperature of the valve.

In particular embodiments, which may combine the features of some or all of the above embodiments, the disclosed method further includes: providing one or more movable second bodies within the chamber, one or more of the second bodies at least partially immersed in the fluid medium during valve operation; and operating the valve by periodically translating the valve relative to the pressurizable enclosure along a longitudinal axis such that one or more of the second bodies move within and relative to the chamber to facilitate reducing an operating temperature of the valve.

In particular embodiments, which may combine the features of some or all of the above embodiments, a cylinder assembly for an engine is disclosed, the cylinder assembly including: a first pressurizable enclosure; a first piston configured to reciprocate within the first pressurizable enclosure; and one or more first valves configured to periodically operate based on a position of the first piston to selectively permit fluid flow into or out of the first pressurizable enclosure, wherein each first valve respectively includes: a valve head provided at a first portion of the first valve; a connecting portion extending between the first portion and a second portion of the first valve provided opposite the first portion; a chamber including a hollow portion provided at least partially within the connecting portion and configured to contain a filler material; and one or more movable bodies disposed within the chamber; wherein, during operation of the first valve, one or more of movable bodies are configured to translate or reciprocate within and relative to the chamber to facilitate reducing an operating temperature of the first valve.

In particular embodiments, which may combine the features of some or all of the above embodiments, the first pressurizable enclosure includes a cylinder of a combustion engine, and wherein at least one of the one or more first valves is an inlet valve or an exhaust valve. In particular embodiments, which may combine the features of some or all of the above embodiments, the filler material includes sodium.

In particular embodiments, which may combine the features of some or all of the above embodiments, each chamber corresponding to the one or more first valves respectively includes an elongated portion oriented along a longitudinal axis, wherein at least one movable body corresponding to each first valve includes a respective elongated portion, and wherein the elongated portion of the at least one movable body is provided coaxially with the elongated portion of the respective chamber.

In particular embodiments, which may combine the features of some or all of the above embodiments, the cylinder assembly further includes one or more second pressurizable enclosures; one or more second pistons respectively configured to reciprocate within the one or more second pressurizable enclosures; and one or more second valves corresponding to each of the one or more second pressurizable enclosures, each second valve respectively configured to periodically operate based on a position of the corresponding second piston to selectively permit fluid flow into or out of the corresponding second pressurizable enclosure, wherein each second valve respectively includes: a valve head provided at a first portion of the second valve; a connecting portion extending between the first portion of the second valve and a second portion of the second valve provided opposite the first portion of the second valve; a chamber including a hollow portion provided at least partially within the connecting portion of the second valve and configured to contain a filler material; and one or more movable bodies disposed within the chamber of the second valve; wherein, during operation of the second valve, one or more of the movable bodies are configured to translate or reciprocate within and relative to the chamber of the second valve to facilitate reducing an operating temperature of the second valve.

### BRIEF DESCRIPTION OF THE DRAWINGS

The following figures are included to illustrate certain aspects of the present disclosure to provide an understanding, and should not be viewed as exclusive embodiments. The subject matter disclosed contemplates and allows for considerable modifications, alterations, combinations, and/or equivalents in form and function, without departing from the scope of this disclosure.

FIG. 1 illustrates a perspective view of exemplary engine cylinders, according to particular embodiments.

FIG. 2A illustrates a cross-sectional view of one of the engine cylinders of FIG. 1, with the piston at top dead center, according to particular embodiments.

FIG. 2B illustrates a cross-sectional view of one of the engine cylinders of FIG. 1, with the piston at bottom dead center, according to particular embodiments.

FIG. 3 illustrates a cross-sectional view of an exemplary valve, according to particular embodiments.

FIG. 4 illustrates exemplary shapes of turbolators, according to particular embodiments.

FIG. 5 illustrates a graph comparing operating temperature profiles of exemplary valves, according to particular embodiments.

### DETAILED DESCRIPTION

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time consuming but would nevertheless be a routine undertaking for those of ordinary skill in the art having the benefit of the present disclosure.

Throughout this disclosure, a reference numeral followed by an alphabetical character may refer to a specific instance of an element, and the reference numeral alone may refer to the element generically or collectively. Thus, as a non-limiting example (not shown in the drawings), widget “1a” may refer to an instance of a widget class, which may be referred to collectively as widgets “1” and any one of which may be referred to generically as a widget “1”. In the figures and the description, like numerals are intended to represent like elements. For clarity, not every element may be labeled or otherwise referenced in every figure. Additionally, not every element illustrated by way of non-limiting example in a given figure need be present in every contemplated embodiment.

The terms “couple” or “couples,” as used herein, are intended to mean either an indirect or direct connection. Thus, if a first device couples to a second device, that connection may be through a direct connection, or through an indirect electrical connection or a shaft coupling via other devices and connections.

To facilitate a better understanding of the present disclosure, the following examples of certain embodiments are given. In no way should the following examples be read to limit, or define, the scope of the disclosure. Embodiments described below with respect to one implementation are not intended to be limiting.

The present disclosure provides for systems and methods for utilizing valves with features for enhanced cooling and/or lower operating temperatures in use. As will be discussed further, disclosed systems and methods may, in certain embodiments, modify rates of heat transfer in or through a valve. By way of example and not limitation, disclosed systems and methods may include one or more movable bodies disposed within a coolant or heat transfer medium provided within a valve. The disclosed valve features may be utilized in passenger cars, trucks, or any other suitable vehicle. While disclosed features may be used in engines, e.g., for engine cylinder valves, and may be described relative to engine cylinders to provide a better understanding, it should be appreciated that the disclosed features are contemplated in the context of valves for any suitable pressurizable containers or enclosures that may benefit from their modification, adaptation, and/or use.

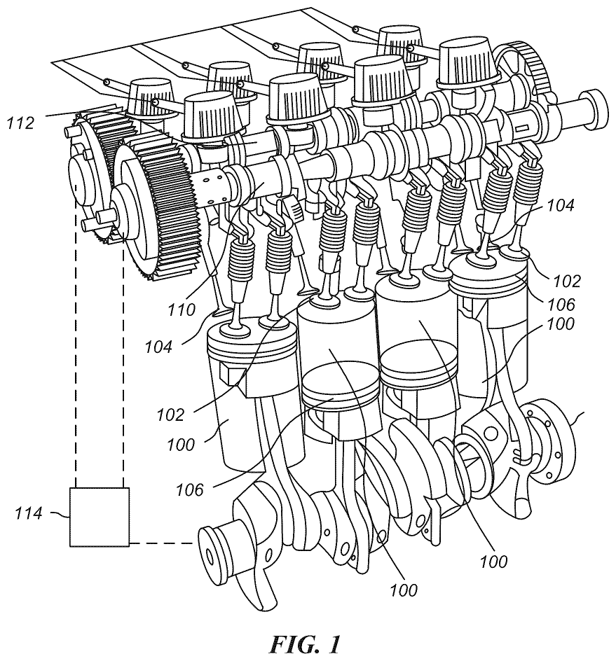

In particular embodiments, an engine may comprise four, six, or eight cylinders, or any other number of cylinders. Other numbers of cylinders can be used without affecting the relevance or applicability of the present disclosure, but for discussion, particular numbers of cylinders may be illustrated in the figures (such as in FIG. 1 by way of example and not limitation). In particular embodiments, an engine may utilize a camshaft system to operate one or more valves, or it may use a camless design, or a hybrid system. By way of example and not limitation, the intake valves and exhaust valves may either couple to a cam system for actuation, a hydraulic rail, a latched rocker arm, other rocker arm, switching roller finger follower, lashed capsule, an electric actuator, a hydraulic actuator, and/or electro-hydraulic actuator, etc. Additional functionality, such as engine braking and hydraulic lash adjustment may be separately or additionally included. In particular embodiments, the cylinders of an engine may receive intake gases. By way of example and not limitation, intake gases may comprise combustible gases, such as air, and/or air mixed with fuel, and/or air mixed with exhaust (exhaust gas recirculation “EGR”), from an intake manifold. In particular embodiments, one or more intake manifold sensors may monitor the pressure, flow rate, oxygen content, exhaust content or other qualities of the intake fluid. In particular embodiments, the intake manifold may connect to intake ports in the engine block to provide intake fluid to the cylinders. In particular embodiments, an intake manifold may be provided at a vacuum relative to the local atmospheric pressure. In particular embodiments, the intake manifold may be boosted to a high pressure relative to the local atmospheric pressure.

In particular embodiments, fuel may be injected to individual cylinders via a suitable fuel distribution and/or injection system. By way of example and not limitation, a fuel distribution and/or injection system may comprise a fuel injection controller. In particular embodiments, a fuel injection controller may adjust the amount and timing of fuel injected into each cylinder, and may be configured to selectively shut off and resume fuel injection to each cylinder. In particular embodiments, a quantity of fuel injected for each cylinder of a multi-cylinder engine may be the same, or may be unique for each cylinder or particular groups of cylinders. By way of example and not limitation, one cylinder may receive more fuel than another, on a time-averaged basis, and another cylinder may receive no fuel at particular times, such as to conserve fuel during low power requirements, or for other operational reasons.

FIG. 1 illustrates a perspective view of example engine cylinders 100 that may employ the aspects of the present disclosure, according to particular embodiments. The engine block of a suitable engine utilizing the engine cylinders 100 is removed from the present example for clarity. In particular embodiments, operation of the engine cylinders 100 may be dependent on intake valves 102, exhaust valves 104, and pistons 106. In particular embodiments, there may be a single intake valve 102, and/or a single exhaust valve 104, and a piston 106 per cylinder 100. In other embodiments, each cylinder 100 may operate with a plurality of intake valves 102, and/or a plurality of exhaust valves 104. As shown in FIG. 1 by way of example and not limitation, piston 106 may be disposed within the cylinder 100, and may be operable to translate within the cylinder 100. In particular embodiments, each piston 106 may be coupled to a crankshaft 108 housed in the engine block. The crankshaft 108 may allow the engine to convert movement of one or more pistons 106 into rotational motion. In particular embodiments, crankshaft 108 may be coupled to transfer energy to one or more camshafts (such as 110, 112, by way of non-limiting example). By way of example and not limitation, crankshaft 108 may transfer energy to one or more camshafts by a torque transfer mechanism 114, which may comprise one or more of gear sets, belts, and/or other transfer mechanisms. In particular embodiments, each intake valve 102 and/or each exhaust valve 104 may couple to a cam system, such as the camshafts 110, 112, respectively as non-limiting examples, for actuation and operation.

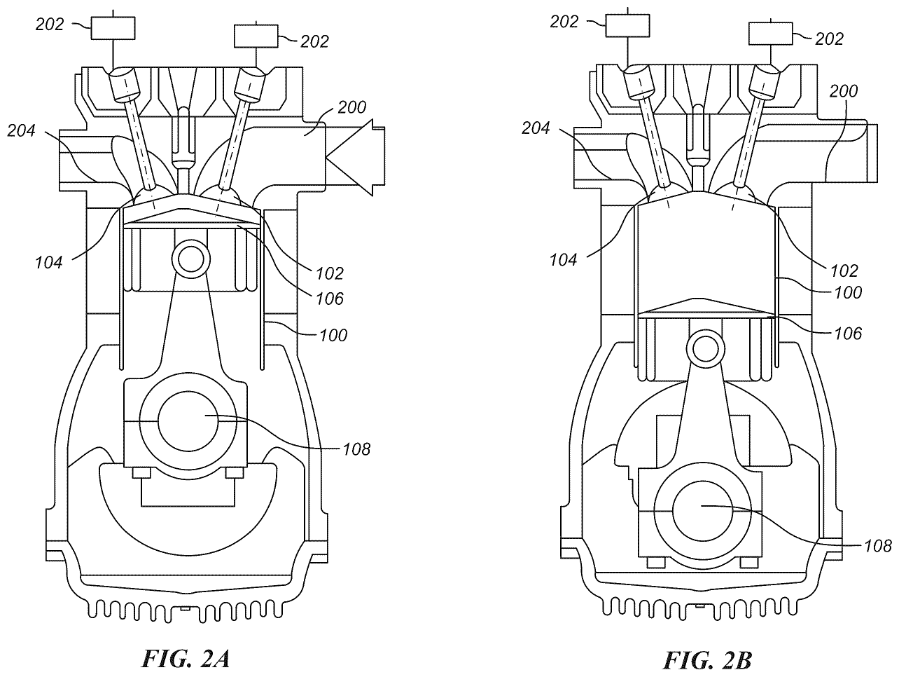

FIGS. 2A-2B illustrate one of the engine cylinders 100 at top dead center and bottom dead center, respectively according to particular embodiments. In particular embodiments, an engine may operate by compressing fluid (such as air, or a mixture of air and fuel, by way on non-limiting example) provided into a cylinder 100 through an intake valve 102 by compression using a piston 106. In particular embodiments, once the intake fluid has moved from the intake manifold to the cylinder 100, it may be referred to as a “charge,” and when the charge moves from the cylinder 100 to an exhaust manifold, it may be referred to as exhaust gas. In particular embodiments, to initiate a combustion phase of engine operation, fuel may be injected via a fuel injector (e.g., in a diesel engine), or a mixture of air and fuel may be ignited using a spark (e.g., in a gasoline engine). By way of example and not limitation, combustion forces due to combustion may force the piston 106 from top dead center (TDC) illustrated in FIG. 2A to bottom dead center (BDC) illustrated in FIG. 2B. In particular embodiments, torque may then be directed to the crankshaft 108 for output, such as to a driveshaft, and/or an affiliated flywheel. In particular embodiments using diesel engines, combustion initiation may be referred to as “compression ignition.” In particular embodiments, combustion initiation in a gasoline engine may use a spark plug to ignite the gasoline.

In particular embodiments, engine operation may encompass a 4-stroke operation. In particular embodiments, other operation modes such as 2-stroke, 6-stroke, and 8-stroke are also possible and contemplated herein. By way of example and not limitation, corresponding to a 4-stroke operation, during a first stroke (“stroke 1) of a 4-stroke cycle, the piston 106 may move from TDC to BDC with one or more intake valves 102 may open, so as to fill the cylinder 100 with intake fluid. In particular embodiments, the intake fluid (such as air, and/or air mixed with fuel and/or exhaust) may flow from an intake manifold into each cylinder through intake ports 200 located in an engine block. In particular embodiments, with all valves closed, the piston 106 may then translate back to TDC (“stroke 2”) to compress the fluid drawn in during intake. In particular embodiments, fuel may be injected (e.g., in a diesel engine) and/or the fluid charge ignited by a spark (e.g., in a gasoline engine) to initiate combustion, thereby pushing the piston 106 to BDC (“stroke 3”). In particular embodiments, the piston 106 may then rise again to TDC with one or more exhaust valves 104 open so as to expel the exhaust out the exhaust valve 104 (“stroke 4”). In particular embodiments, the intake valve 102 may be open during stroke 1 and closed during strokes 2-4, wherein the intake valve 102 may be seated against the intake port 200. In particular embodiments, the exhaust valve 104 may be open during stroke 4 and closed during strokes 1-3, wherein the exhaust valve 104 may seated against an exhaust port 204. In particular embodiments, compression occurs on the second stroke, and combustion and/or power output occurs on the third stroke. In particular embodiments, 6-stroke and 8-stroke techniques may include additional aspects of compression and/or injection after the intake valve 102 has closed, and/or prior to the exhaust valve 104 opening. It will be appreciated that while the present disclosure describes 4-stroke combustion techniques in detail to provide an understanding, aspects of the disclosure are contemplated for applicability to other cycles and modes of operation. Separately or additionally, particular 4-stroke techniques may be applicable to 6-stroke or 8-stroke techniques.

In particular embodiments, the intake and exhaust valves, 102 and 104 respectively, may be actuated by valve actuators 202. In particular embodiments, each valve 102, 104 may be actuated by a dedicated valve actuator 202, or actuation may be split or shared. By way of example and not limitation, a particular valve actuator may provide actuation of multiple valves, which may span multiple cylinders in particular embodiments, and/or cover groups comprising both intake and exhaust valve combinations. In particular embodiments, the valve actuator 202 may be any suitable component for operating engine valves, such as a mechanical, hydraulic, electric, and/or electric solenoid systems to control the intake and exhaust valves 102, 104. In particular embodiments, the valve actuators 202 for each cylinder 100 may be the same for all cylinders 100, or may differ between the intake valves 102 and the exhaust valves 104 so that certain functionality may be only enabled on one or the other of those valves. In particular embodiments, when more than one intake valve 102 or more than one exhaust valve 104 are used per cylinder 100, the valve actuators 202 may be the same or different for each of those valves. In particular embodiments, one or more valves, such as inlet valves 102 and/or exhaust valves 104, may be operated by cams provided on camshafts to periodically engage with the valve.

In particular embodiments, exhaust gases may leave cylinders 100 through exhaust ports 204 in an engine block. In particular embodiments, exhaust ports 204 may communicate with an exhaust manifold. In particular embodiments, an exhaust manifold sensor may be configured to monitor the pressure, flow rate, oxygen content, nitrous or nitric oxide (NOx) content, sulfur content, other pollution content or other qualities of the exhaust gas. In particular embodiments, the exhaust gas can power a turbine of turbocharger, which can be a variable geometry turbocharger (VGT) or other turbocharger. In particular embodiments, a turbocharger may be adjusted so as to control intake or exhaust flow rate or back pressure in the exhaust.

In particular embodiments, compressed gases, combusting gases, and/or combustion products may provide an environment proximal to one or more inlet valves 102 and/or exhaust valves 104 comprising high heat fluxes and loads, and/or elevated temperatures. By way of example and not limitation, exhaust gases leaving each cylinder 100 may impinge on each inlet valve 102, and/or flow over and around each exhaust valve 104. By way of example and not limitation, exhaust valves 104 may receive significant heat loads and heat fluxes, and/or experience high temperatures. In certain embodiments, the exhaust valves 104 may fail due to the increase in heat and elevated temperature. In particular embodiments, to increase cooling performance of the valves and/or to improve fatigue life of one or more valves, designs and features for enhancing cooling of the valves may be used. In particular embodiments, hollow valves may be used to improve cooling performance of the valves in operation. In particular embodiments, a heat transfer medium and/or filler medium may be used within one or more chambers located within a valve. In particular embodiments, a heat transfer medium and/or filler medium provided within a hollow chamber of a valve may perform and/or behave as a fluid medium at engine and valve operating conditions, such as due to operating conditions of elevated temperature relative to room temperature. In particular embodiments, one or more movable bodies may be further provided within one or more chambers or enclosures disposed within a valve.

In particular embodiments, one or more movable bodies disposed within the hollow valve may be at partially immersed in a fluid medium provided therein at engine operating conditions. In particular embodiments, one or more movable bodies may translate, reciprocate, oscillate, and/or otherwise move within their corresponding chamber(s) or enclosure(s) provided within a valve. By way of example and not limitation, motion of the one or more movable bodies within a hollow chamber or enclosure, such as immersed in a fluid heat transfer medium provided therein, may be based on a motion of the operating valve, such as due to opening and/or closing motion of the valve.

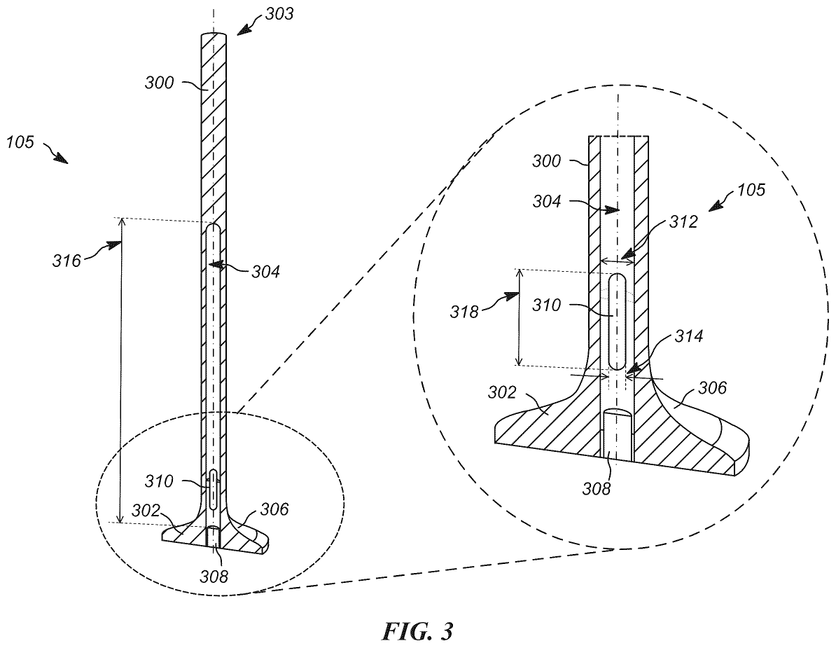

FIG. 3 illustrates a cross-sectional view of an exemplary valve 105, according to particular embodiments. In particular embodiments, valve 105 may designed for enhanced cooling and/or for reducing valve temperatures during operation. In particular embodiments, valve 105 may be identical, equivalent, and/or otherwise usable as an exhaust valve 104, and/or an intake valve 102, and/or any other kind of suitable valve, and the disclosure may accordingly apply to these and any other suitable valves. Not all features illustrated by way of non-limiting example in FIG. 3, or any other figure, are required in every embodiment of use of the disclosed features. By way of example and not limitation, a valve 105 may comprise a construction without using a plug 308.

In particular embodiments, valve 105 may be any suitable size, height, shape, and any combinations thereof. Further, valve 105 may comprise any suitable materials, such as metals, nonmetals, polymers, composites, and/or any combinations thereof. In particular embodiments, valve 105 may comprise a stem 300, a valve head 302, and/or a valve end 303. In particular embodiments, valve 105 may comprise an internal chamber 304. In particular embodiments, the stem 300 and/or valve end 303 may be configured for coupling and/or engaging with a valve actuator (such as valve actuator 202 illustrated in FIGS. 2A-2B, by way of non-limiting example). In particular embodiments, the valve head 302 may be coupled to the stem 300 at an end opposite from valve end 303. In particular embodiments, the valve head 302 may be securely coupled to, and/or integrally formed with, stem 300. In particular embodiments, the stem 300 may extend from the valve head 302. In particular embodiments, a fillet 306 may be formed by the joint manufacture of the stem 300 and valve head 302, wherein the fillet 306 may be disposed between the stem 300 and valve head 302. In particular embodiments, during engine and valve operation, the stem 300 may transfer force and motion provided by the valve actuator to the valve head 302. In particular embodiments, the stem 300 may support or sustain significant gas pressures received by valve head 302. In particular embodiments, the valve head 302 may be configured to seat against an opening of the cylinder 100, such as an opening of intake port 200 or exhaust port 204, wherein the opening may provide fluid communication into and out of the cylinder (referring to FIGS. 1 and 2A-2B). In particular embodiments, actuation of the valve 105 such that valve head 302 may cover or uncover a particular fluid port (such as intake port 200 or exhaust port 204) may selectively permit or deny fluid communication to the cylinder 100.

In particular embodiments, as illustrated by way of non-limiting example in FIG. 3, the internal chamber 304 may be disposed within the stem 300. In particular embodiments, internal chamber 304 may be sealed within the valve 105. In particular embodiments, internal chamber 304 may further extend and terminate through a portion of the valve head 302. In particular embodiments, internal chamber 304 may be any suitable size, height, shape, and any combinations thereof. By way of example and not limitation, as illustrated in FIG. 3, the internal chamber 304 may generally be cylindrical in shape and/or concentric or coaxial with stem 300, but the internal chamber 304 is not limited to this shape and configuration. In particular embodiments, to form the internal chamber 304, tube-to-solid (“TTS”) and/or top-of-head (“TOH”) manufacturing processes may be used with the stem 300 and valve head 302. By way of example and not limitation, during TTS, the stem 300 and valve head 302 may be forged as a singular piece. In particular embodiments, a TTS operation may involve drilling through the stem 300. By way of example and not limitation, drilling through stem 300 may comprise starting from valve end 303 opposite the valve head 302, and continuing through the stem 300, so as to terminate at least partially through the valve head 302. In particular embodiments, a secondary structure may then be welded to the open end of the stem 300 to seal the formed internal chamber 304. In particular embodiments, during an exemplary TOH operation, the stem 300 and valve head 302 may be forged as a singular piece. In particular embodiments, the operation may then comprise drilling through the valve head 302 and continuing through the stem 300 to terminate at some location within the stem 300. In particular embodiments, a plug 308 may then be inserted into the opening of the valve head 302 to seal the internal chamber 304, and the plug 308 may be welded within the valve head 302.

In particular embodiments, internal chamber 304 may be a cavity configured to receive, enclose, and/or contain a filler medium. By way of example and not limitation, a filler medium may comprise a coolant and/or a heat transfer medium. In particular embodiments, a coolant or a heat transfer medium may comprise any suitable material operable to regulate a temperature of the valve 105, and/or to improve heat transfer characteristics of valve 105. By way of example and not limitation, a coolant or filler medium may comprise sodium, cesium, potassium, water, and/or the like. In particular embodiments, during manufacture and assembly of valve 105, the filler medium, which may comprise a heat transfer medium or coolant, may be inserted into the internal chamber 304 prior to sealing the internal chamber 304.

In particular embodiments, valve 105 may further comprise one or more bodies, such as turbolator 310 by way of example and not limitation, which may be provided within internal chamber 304. In particular embodiments, one or more bodies provided within internal chamber 304 may be configured to move within internal chamber 304, and/or relative to the walls of internal chamber 304, and/or relative to fixed aspects of valve 105. While further description of one or more such movable bodies will be provided with reference to turbolator 310 to provide a non-limiting illustrative example for understanding, it should be appreciated that any suitable body or bodies provided within valve 105 are fully contemplated herein. Any disclosure provided with reference to turbolator 310 may accordingly apply to one or more movable bodies provided within valve 105, such as within internal chamber 304. By way of example and not limitation, the term “turbolator” used for denoting non-limiting examples of movable bodies provided within valve 105, such as turbolator 310, should not be considered as limiting therefore in terms of any possible or suggestible implications, such as turbulence.

In particular embodiments, turbolator 310 may be disposed within the internal chamber 304. In particular embodiments, turbolator 310 may be at least partially disposed within a filler medium, and/or a heat transfer medium or coolant. In particular embodiments comprising a fluid phase heat transfer medium or coolant within internal chamber 304, turbolator 310 may be at least partially immersed within a filler medium, and/or a heat transfer medium or coolant during valve operation.

In particular embodiments, turbolator 310 may be configured to facilitate mixing and/or enhanced thermal transport and/or enhanced momentum transport flow of within valve 105. By way of example and not limitation, turbolator 310 may be configured to promote mixing and/or convection of a fluid-phase heat transfer medium or coolant provided within internal chamber 304, such as during engine and valve operation of valve 105. In particular embodiments, turbolator 310 may be configured to translate, reciprocate, oscillate, and/or otherwise move within the internal chamber 304 and/or interact with the heat transfer medium or coolant.

In particular embodiments, turbolator 310 may be configured to move within internal chamber 304 based on a motion of valve 105 during operation of valve 105. By way of example and not limitation, a periodic translation and/or a reciprocal motion of valve 105 can facilitate a motion of turbolator 310 within internal chamber 304 by a transfer of energy. In particular embodiments, turbolator 310 may be configured to move within internal chamber 304 based on additional or alternative drivers of motion than a motion of valve 105. By way of example and not limitation, a motion of turbolator 310 may be facilitated by natural convection currents in a fluid-phase coolant or heat transfer medium provided within internal chamber 304. By way of example and not limitation, a motion of turbolator 310 may be facilitated by other forces, such as other mechanical and/or electromagnetic forces. By way of example and not limitation, electromagnetic forces, such as from a coil or driver, may act on a responsive material and/or component of turbolator 310 to facilitate a motion of turbolator 310 within internal chamber 304.

In particular embodiments, a movement of turbolator 310 may provide increased fluid motion of the heat transfer medium or coolant, thereby increasing heat transfer in valve 105 away from valve head 302, such as by thermal convection, and/or such as toward valve end 303 and/or lower temperature boundary conditions for valve 105 than valve head 302. In particular embodiments, separately or additionally, a movement of turbolator 310 may promote or increase a turbulence level of a fluid-phase heat transfer medium or coolant within internal chamber 304, which can increase heat transfer in valve 105 away from valve head 302, such as by thermal convection. Accordingly, a motion of turbolator 310 within valve 105 (e.g., within internal chamber 304) can provide significantly enhanced cooling of valve 105 in operation, accordingly facilitating lower operating temperatures of valve 105, especially but not limited to portions of valve 105 at and/or proximal to valve head 302.

In particular embodiments, turbolator 310 may provide for increased cooling of the exhaust valve by facilitating and increase in heat transfer from the valve head 302 up through the stem 300. In particular embodiments, certain valves 105, such as particular exhaust valves 104, may only transfer heat through conduction from the valve heads 302 up through the respective stems 300. In particular embodiments, the present disclosure provides for heat transfer through both conduction and convection. In particular embodiments, turbolator 310 may provide for further increased performance through enhanced convection, such as by increasing the fluid motion and/or mixing of the heat transfer medium or coolant within the internal chamber 304. In particular embodiments, an operating temperature reduction of valve 105 may improve fatigue life of the valve 105, and/or may provide for usage of lower grade alloys (from high-content nickel alloy to austenitic alloy). In particular embodiments, an operating temperature reduction of valve 105 may permit use of different and/or less expensive materials and/or processes for manufacturing valve 105. In particular embodiments, an operating temperature reduction of valve 105 may permit use of thermodynamically more efficient engine designs, cycles, or parameters, such as by permitting a higher compression ratio, and/or higher brake mean effective pressures, and/or higher levels of turbocharging than would be survivable by an engine valve not provided with one or more of the features disclosed herein.

In particular embodiments, turbolator 310 may be any suitable size, height, shape, and any combinations thereof. Further, the turbolator 310 may comprise any suitable materials, such as one or more metals. By way of example and not limitation, such as illustrated in FIG. 3, the turbolator 310 may generally be cylindrical in shape, such as a rod, but the turbolator 310 is not limited to this shape and configuration. By way of example and not limitation, turbolator 310 may generally be in the shape of a sphere, a hemisphere, a ball, a cube, a polygon, or any other suitable shape. By way of example and not limitation, turbolator 310 may comprise one or more portions that are spherical or hemispherical.

In particular embodiments, turbolator 310 may comprise an elongated portion. By way of example and not limitation, such as illustrated in FIG. 3, an elongated portion of a turbolator 310 may be oriented along a longitudinal axis of valve 105. In particular embodiments, an elongated portion of a turbolator 310 may be provided coaxially provided with an elongated portion of internal chamber 304. In particular embodiments, such as illustrated in FIG. 3 by way of example and not limitation, a cross-sectional dimension of turbolator 310 can be narrower than a corresponding cross-sectional inner dimension of internal chamber 304, and/or in some non-limiting case, significantly narrower. By way of example and not limitation, a cross-sectional diameter 312 of internal chamber 304 may be between one and five times the value of a cross-sectional diameter 314 of a turbolator 310. In particular embodiments, cross-sectional diameter 312 of internal chamber 304 may be one to ten times larger than cross-sectional diameter 314 of turbolator 310. By way of example and not limitation, herein “diameter” may refer to a circular cross-sectional shape of one or both of internal chamber 304 and/or turbolator 310, and/or “diameter” may refer to another suitable length scale, such as a hydraulic diameter, of a non-circular cross-sectional shape of one or both of internal chamber 304 and/or turbolator 310. Accordingly, in particular embodiments, turbolator 310 may exhibit rolling, yawing, tumbling, and/or other non-axial components of motion during an overall motion of turbolator 310 within 304. In particular embodiments, a longitudinal axis of turbolator 310 may be only occasionally aligned with a corresponding longitudinal axis of internal chamber 304 and/or of valve 105 in time, or their respective longitudinal axes may not align at all.

In particular embodiments, such as illustrated in FIG. 3 by way of non-limiting example, a length of internal chamber 304 can be longer than a length of turbolator 310. By way of example and not limitation, a length 316 of internal chamber 304 may have a value between one time and fifty times a length 318 of turbolator 310. By way of example and not limitation, a length 316 of internal chamber 304 may have a value between one time and one hundred times a length 318 of turbolator 310. In particular embodiments, a length of internal chamber 304 and/or turbolator 310 may be substantially aligned with a longitudinal axis of the valve.

In particular embodiments, the turbolator 310 may require, or benefit from, particular masses and/or mass distributions for accomplishing a desired movement within the internal chamber 304. By way of example and not limitation, one or more parameters of turbolator 310 may be determined based on a balance of multiple interacting factors. By way of example and not limitation, turbolator 310 may comprise a thermally conductive material, such as one or more metals. By way of example and not limitation, some factors may comprise buoyancy forces, inertial forces, form and/or friction drag forces, gravitational forces, and/or resonance factors. In particular embodiments, turbolator 310 may comprise a shape and/or size less than the lateral dimensions of the internal chamber 304 (for example, a diameter less than the diameter of the internal chamber 304), such as to provide for fluid flow around the turbolator 310 within the internal chamber 304 (i.e., the turbolator may not be a choking point in such examples). In particular embodiments, there may be a plurality of turbolators 310 disposed within the internal chamber 304. In particular embodiments, a plurality of turbolators 310 may collectively function as effectively or more effectively than a singular turbolator 310. In particular embodiments, turbolators 310 of a plural set may be identical or non-identical. In particular embodiments, a plural set of turbolators 310 may comprise turbolators laterally aligned within chamber 304, or longitudinally aligned within chamber 304, or any combination thereof. In particular embodiments, during manufacture and assembly of the exhaust valve 104, the turbolator 310 or plurality of turbolators 310 may be inserted into the internal chamber 304 prior to sealing the internal chamber 304.

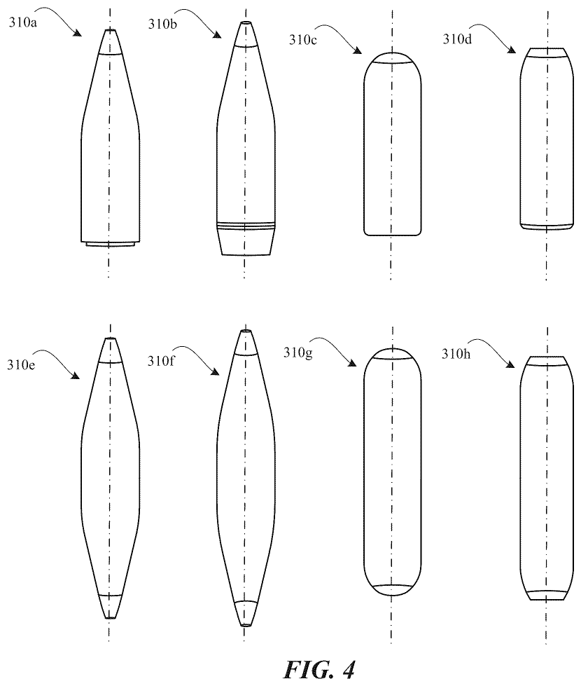

FIG. 4 illustrates exemplary shapes of turbolators 310a through 310h, according to particular embodiments. By way of example and not limitation, such as illustrated by 310a-310d, turbolator 310 may be asymmetric fore and aft, i.e., along a longitudinal axis of turbolator 310 and/or along a general direction of intended motion of turbolator 310 during valve operation. By way of example and not limitation, a portion of turbolator 310 may comprise a streamlined shape. By way of example and not limitation, such as illustrated by upper portions of 310a and 310b, a portion of turbolator 310 may comprise a tapering or narrowing section. By way of example and not limitation, such as illustrated by lower portions of 310a or 310c, a portion of turbolator 310 may comprise a blunt or bluff portion. In particular embodiments, an asymmetric shape of turbolator 310 may be oriented with a relatively streamlined portion pointing generally upward (i.e., generally against a gravitational direction) or pointing generally downward (i.e., generally toward a gravitational direction). In particular embodiments, such as illustrated by 310e-310h, turbolator 310 may be symmetric fore and aft, i.e., along a longitudinal axis of turbolator 310 and/or along a general direction of intended motion of turbolator 310 during valve operation.

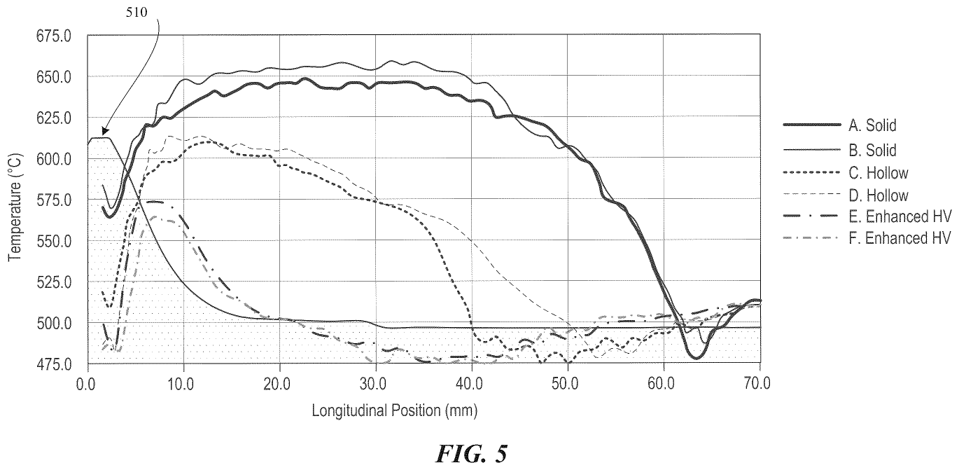

FIG. 5 illustrates a graph comparing operating temperature profiles of exemplary valves, according to particular embodiments. By way of example and not limitation, a temperature profile comparison is provided among otherwise comparable solid valves (labeled “solid”), sodium-filled hollow valves (labeled “hollow”), and sodium-filled hollow valves including a turbolator 310 (labeled “enhanced HV”). A longitudinal sectional profile 510 of a valve is provided to indicate a longitudinal position corresponding to temperatures for each exemplary valve's profile. For example, position origin 0.0 indicates a cylinder-facing reference position of valve head 302 for each profiled valve, with increasing distances indicating farther longitudinal positions along stem 300 for each profiled valve. By way of example and not limitation, such as illustrated for time-averaged longitudinal profiles of operating temperature, solid valves ‘A’ and ‘B’ generally have the highest operating temperatures, followed by sodium-filled hollow valves (without turbolator 310) ‘C’ and ‘D’. As illustrated, valves ‘E’ and ‘F’, marked “Enhanced HV” and corresponding to sodium-filled hollow valves (HV indicating hollow valve) that comprise turbolators 310, exhibit the lowest temperature profiles during engine and valve operation. In particular, ‘E’ and ‘F’ have significantly lower temperatures at low values of longitudinal position, i.e., in and near valve head 302 which faces large heat loads and can be susceptible to failure. ‘E’ and ‘F’ also show generally lower temperatures overall, i.e., over the profile. Accordingly, the thermal performance characteristics of the presently disclosed exemplary valves 105 show lower operating temperatures than valves without one or more features disclosed herein, which lower temperatures of presently disclosed exemplary valve 105 initiate at a closer distances to the valve head 302 than do the other valves.

It will be appreciated that FIG. 5 is disclosed herein to provide examples for a better understanding, and is not to be construed as qualitatively or quantitively limiting in any way.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A valve for a pressurizable enclosure, the valve comprising:
a valve head provided at a first portion of the valve and configured to engage with the pressurizable enclosure to selectively permit fluid flow into or out of the pressurizable enclosure;
a connecting portion extending between the first portion and a second portion of the valve provided opposite the first portion;
a chamber comprising a hollow portion provided at least partially within the connecting portion and configured to contain a filler material; and
a first body disposed within the chamber and comprising a first portion, a second portion provided opposite the first portion, and a third portion disposed between the first portion and the second portion;
wherein, during valve operation, the first body is configured to be movable within the chamber to facilitate reducing an operating temperature of the valve, and
wherein one or more of the first portion of the first body or the second portion of the first body are configured to taper along a direction away from the third portion of the first body.

2. The valve of claim 1, wherein the filler material comprises a fluid medium during valve operation, and wherein the first body is at least partially immersed in the fluid medium during valve operation.

3. The valve of claim 1, wherein valve operation comprises a periodic translation or a reciprocal motion of the valve relative to the pressurizable enclosure along a longitudinal axis.

4. The valve of claim 3, wherein a motion of the first body is facilitated by the periodic translation or the reciprocal motion of the valve during valve operation.

5. The valve of claim 1, wherein the chamber comprises an elongated portion oriented along a longitudinal axis of the valve, and wherein the first body is configured to reciprocate or translate within the elongated portion of the chamber during valve operation.

6. The valve of claim 5, wherein the first body comprises an elongated portion provided coaxially with the elongated portion of the chamber.

7. The valve of claim 6, wherein a ratio of a cross-sectional diameter of the chamber and a cross-sectional diameter of the first body has a value between one and five.

8. The valve of claim 1, further comprising one or more second bodies disposed within the chamber, each second body configured to be movable within the chamber during valve operation.

9. The valve of claim 1, wherein the third portion comprises an elongated section oriented along a longitudinal axis of the valve.

10. The valve of claim 1, wherein the valve is an intake valve or an exhaust valve of a combustion engine, and wherein a motion of the first body within the chamber during valve operation permits an increased rate of heat transfer through the connecting portion of the valve to facilitate reducing the operating temperature of the valve.

11. The valve of claim 1, wherein the filler material comprises sodium.

12. The valve of claim 1, wherein reducing an operating temperature of the valve comprises reducing a mean temperature of the valve head during valve operation.

13. A method to facilitate reducing an operating temperature of a valve of a pressurizable enclosure, the method comprising:
providing a movable first body within a chamber of the valve, the first body comprising a first portion, a second portion provided opposite the first portion, and a third portion disposed between the first portion and the second portion, the chamber provided at least partially within a connecting portion extending between a valve head and a valve end of the valve, the chamber configured to contain a filler material, the filler material comprising a fluid medium during valve operation, the first body at least partially immersed in the fluid medium during valve operation; and
operating the valve by periodically translating the valve relative to the pressurizable enclosure along a longitudinal axis such that the first body moves within the chamber to facilitate reducing an operating temperature of the valve,
wherein one or more of the first portion or the second portion of the first body are configured to taper along a direction away from the third portion.

14. The method of claim 13, further comprising:
providing one or more movable second bodies within the chamber, one or more of the second bodies at least partially immersed in the fluid medium during valve operation; and
operating the valve by periodically translating the valve relative to the pressurizable enclosure along a longitudinal axis such that one or more of the second bodies move within the chamber to facilitate reducing an operating temperature of the valve.

15. A cylinder assembly for an engine comprising:
a first pressurizable enclosure;
a first piston configured to reciprocate within the first pressurizable enclosure; and
one or more first valves configured to periodically operate based on a position of the first piston to selectively permit fluid flow into or out of the first pressurizable enclosure, wherein each first valve respectively comprises:
a valve head provided at a first portion of the first valve;
a connecting portion extending between the first portion and a second portion of the first valve provided opposite the first portion;
a chamber comprising a hollow portion provided at least partially within the connecting portion and configured to contain a filler material; and
one or more movable bodies disposed within the chamber;
wherein at least one movable body of the one or more movable bodies comprises a first portion, a second portion provided opposite the first portion, and a third portion disposed between the first portion and the second portion,
wherein one or more of the first portion or the second portion of the at least one movable body are configured to taper along a direction away from the third portion of the at least one movable body, and
wherein, during operation of the first valve, one or more of the movable bodies are configured to translate or reciprocate within the chamber to facilitate reducing an operating temperature of the first valve.

16. The cylinder assembly of claim 15, wherein the first pressurizable enclosure comprises a cylinder of a combustion engine, wherein at least one of the one or more first valves is an inlet valve or an exhaust valve, and wherein the filler material comprises sodium.

17. The cylinder assembly of claim 15, wherein each chamber corresponding to the one or more first valves respectively comprises an elongated portion oriented along a longitudinal axis, wherein the at least one movable body corresponding to each first valve comprises a respective elongated portion, and wherein the elongated portion of the at least one movable body is provided coaxially with the elongated portion of the respective chamber.

18. The cylinder assembly of claim 15, wherein the filler material comprises a fluid medium during valve operation, and wherein one or more of the movable bodies are at least partially immersed in the fluid medium during valve operation.

19. The cylinder assembly of claim 15, wherein, for each first valve, periodic operation comprises a periodic translation or a reciprocal motion of the first valve relative to the first pressurizable enclosure.

20. The cylinder assembly of claim 15, further comprising:
one or more second pressurizable enclosures;
one or more second pistons respectively configured to reciprocate within the one or more second pressurizable enclosures; and
one or more second valves corresponding to each of the one or more second pressurizable enclosures, each second valve respectively configured to periodically operate based on a position of the corresponding second piston to selectively permit fluid flow into or out of the corresponding second pressurizable enclosure, wherein each second valve respectively comprises:
a valve head provided at a first portion of the second valve;
a connecting portion extending between the first portion of the second valve and a second portion of the second valve provided opposite the first portion of the second valve;
a chamber comprising a hollow portion provided at least partially within the connecting portion of the second valve and configured to contain a filler material; and
one or more movable bodies disposed within the chamber of the second valve;
wherein, during operation of the second valve, one or more of the movable bodies are configured to translate or reciprocate within the chamber of the second valve to facilitate reducing an operating temperature of the second valve.
